(19) United States
(12) Patent Application Publication
(10) Pub. No.: US 2026/0322023 A1
(43) Pub. Date: Oct. 15, 2026

(54) CONNECTOR

(71) Applicant: IRISO ELECTRONICS CO., LTD., Yokohama-shi (JP)

(72) Inventor: Hitoshi TANAKA, Yokohama-shi (JP)

(21) Appl. No.: 19/484,913

(22) PCT Filed: May 21, 2024
(86) PCT No.: PCT/JP2024/018683

§ 371 Date: Nov. 17, 2025

(30) Foreign Application Priority Data
May 23, 2023 (JP) 2023-084851

(51) Int. Cl. H01R 13/405; H01R 13/24; H01R 13/504

(52) U.S. Cl. CPC H01R 13/405; H01R 13/24; H01R 13/5045

(57) ABSTRACT

Provided is a connector having a novel terminal holding structure. A terminal 20 included in a connector 10 includes a held portion 22 and two branch portions 23a. The held portion 22 is press-fitted into a housing 40 with a direction perpendicular to the terminal width direction as a press-fitting direction. The held portion 22 is held by the housing 40 at a position between the two branch portions 23a in a terminal width direction. End surfaces 22a1 on both sides in the width direction of the held portion 22 are not in contact with the housing 40.

### TECHNICAL FIELD

The present disclosure relates to a connector.

### BACKGROUND ART

A connector disclosed in Patent Literature 1 includes a terminal, a fixed housing, and a movable housing. The terminal includes a fixing-side held portion held by the fixed housing, a movable-side held portion held by the movable housing, and an intermediate portion elongated from the fixing-side held portion to the movable-side held portion. The intermediate portion includes a spring portion that enables movement of the movable-side held portion with respect to the fixing-side held portion. Therefore, movement of the movable housing with respect to the fixed housing is allowed.

### CITATION LIST

### Patent Literature

Patent Literature 1: Japanese Patent Application Laid-Open (JP-A) No. 2017-010807

### SUMMARY OF INVENTION

### Technical Problem

A first object of the disclosure is to provide a connector that has a desired movable force and is small in a direction corresponding to a terminal front-rear direction and a terminal up-down direction.

A second object of the disclosure is to provide a connector having a novel terminal holding structure.

### Solution to Problem

### (First Aspect)

A connector according to an aspect 1-1 is a connector to be used by being attached to an attachment surface of an attachment object, the connector including: a terminal; a fixed housing fixed to the attachment object; and a movable housing movable with respect to the fixed housing, in which the terminal includes: a fixing-side held portion held by the fixed housing; a movable-side held portion held by the movable housing; and an intermediate portion elongated from the fixing-side held portion to the movable-side held portion, regarding the terminal, in a case in which a direction perpendicular to the attachment surface and away from the attachment surface is referred to as a terminal upward direction, a direction in which the movable-side held portion is located with respect to the fixing-side held portion in a direction parallel to the attachment surface is referred to as a terminal forward direction, and a direction perpendicular to the terminal forward direction in a direction parallel to the attachment surface is referred to as a terminal width direction, the intermediate portion includes a first spring portion that enables movement of the movable-side held portion with respect to the fixing-side held portion, a plate thickness direction of the first spring portion being substantially parallel to a first direction, and the first spring portion includes a width-direction elongated portion that is a portion having a component whose elongation direction is the terminal width direction.

In this aspect, the connector is a connector to be used by being attached to an attachment surface of an attachment object.

The connector includes a terminal, a fixed housing, and a movable housing. The fixed housing is fixed to the attachment object. The movable housing is movable with respect to the fixed housing.

The terminal includes a fixing-side held portion, a movable-side held portion, and an intermediate portion. The fixing-side held portion is held by the fixed housing. The movable-side held portion is held by the movable housing. The intermediate portion is elongated from the fixing-side held portion to the movable-side held portion.

Here, the intermediate portion includes a first spring portion. The first spring portion enables movement of the movable-side held portion with respect to the fixing-side held portion. A plate thickness direction of the first spring portion is substantially parallel to a first direction.

Therefore, the movable force in the first direction can be reduced by the first spring portion.

The movable force in the first direction means a force required to move the movable housing in the first direction. The term “substantially parallel” as used herein includes not only a parallel relationship but also a slightly inclined relationship.

In this aspect, the first spring portion includes a width-direction elongated portion. The width-direction elongated portion is a portion having a component whose elongation direction is a terminal width direction.

Therefore, as compared with an aspect in which the first spring portion does not include the width-direction elongated portion (see, for example, the connector disclosed in Patent Literature 1), the length of the first spring portion can be secured without increasing the size of the first spring portion in the terminal front-rear direction and the terminal up-down direction. Therefore, it is possible to realize a connector that has a desired movable force and is small in a direction corresponding to a terminal front-rear direction and a terminal up-down direction.

In the embodiment described later, the elongation direction of the width-direction elongated portion of the first spring portion is a direction parallel to the width direction. However, the elongation direction of the width-direction elongated portion of the first spring portion of this aspect is not limited thereto. The width-direction elongated portion may have a component whose elongation direction is a terminal width direction. Therefore, the elongation direction of the width-direction elongated portion may be a direction oblique to the terminal width direction.

In the embodiment described later, the movable-side held portion is located at substantially the same position as the fixing-side held portion in the terminal up-down direction. However, the movable-side held portion of this aspect is not limited thereto.

In the embodiment described later, the terminal is branched at the intermediate portion. However, the terminal of this aspect is not limited thereto.

In the embodiment described later, the intermediate portion has a shape in which the plate thickness direction is changed in a plane perpendicular to the terminal width direction, and does not include a portion whose plate thickness direction faces a direction intersecting the direction perpendicular to the terminal width direction. However, the intermediate portion of this aspect is not limited thereto.

In the embodiment described later, the first direction is a terminal front-rear direction, but the first direction of this aspect is not limited thereto.

In the embodiment described later, the movable range of the movable housing in the direction corresponding to the terminal width direction is ¼ or less of the movable range of the movable housing in the direction corresponding to the terminal front-rear direction. However, the movable housing of this aspect is not limited thereto.

In a connector according to an aspect 1-2, in the aspect 1-1, the first direction is a terminal front-rear direction.

In this aspect, the first direction is a terminal front-rear direction.

Therefore, the movable force in the terminal front-rear direction can be reduced by the first spring portion.

In a connector according to an aspect 1-3, in the aspect 1-1 or 1-2, in the width-direction elongated portion of the first spring portion, the elongation direction of the first spring portion is reversed in a second direction that is a direction perpendicular to both the first direction and the terminal width direction.

In this aspect, in the width-direction elongated portion of the first spring portion, the elongation direction of the first spring portion is reversed in a second direction. The second direction is a direction perpendicular to both the first direction and the terminal width direction.

Therefore, the spring length of the first spring portion can be secured without increasing the size of the first spring portion in the first direction.

In a connector according to an aspect 1-4, in the aspect 1-3, the first spring portion includes: a first width-direction elongated portion that is the width-direction elongated portion; and a second width-direction elongated portion that is a portion having a component whose elongation direction is the terminal width direction, and the elongation direction of the first spring portion is reversed in the second direction also in the second width-direction elongated portion.

In this aspect, the first spring portion includes a first width-direction elongated portion that is the width-direction elongated portion, and a second width-direction elongated portion that is a portion having a component whose elongation direction is the terminal width direction.

Here, also in the second width-direction elongated portion, the elongation direction of the first spring portion is reversed in the second direction.

Therefore, the spring length of the first spring portion can be further secured.

In a connector according to an aspect 1-5, in any one of the aspects 1-1 to 1-4, the intermediate portion includes: a second spring portion that enables movement of the movable-side held portion with respect to the fixing-side held portion, a plate thickness direction of the second spring portion being substantially parallel to the first direction; and a coupling portion that couples the first spring portion and the second spring portion to each other, and the second spring portion is located at a position different from the first spring portion in the first direction.

In this aspect, the intermediate portion includes a second spring portion. The second spring portion enables movement of the movable-side held portion with respect to the fixing-side held portion. A plate thickness direction of the second spring portion is substantially parallel to a first direction.

Therefore, the movable force in the first direction can be reduced by the second spring portion.

The second spring portion is located at a position different from the first spring portion in the first direction. The intermediate portion includes a coupling portion that couples the first spring portion and the second spring portion to each other.

Therefore, the spring length of the intermediate portion can be secured using a space in the first direction.

In the embodiment described later, the coupling portion includes a pair of curved portions and a straight portion. However, the coupling portion of this aspect is not limited thereto, and may be formed only of a curved portion.

In a connector according to an aspect 1-6, in the aspect 1-5, the second spring portion includes a width-direction elongated portion that is a portion having a component whose elongation direction is the terminal width direction.

In this aspect, the second spring portion includes a width-direction elongated portion that is a portion having a component whose elongation direction is the terminal width direction.

Therefore, the spring length of the second spring portion can be increased as compared with an aspect in which the second spring portion does not include the width-direction elongated portion.

In a connector according to an aspect 1-7, in the aspect 1-6, in the width-direction elongated portion of the second spring portion, the elongation direction of the second spring portion is not reversed in the second direction.

In this aspect, in the width-direction elongated portion of the second spring portion, the elongation direction of the second spring portion is not reversed in the second direction.

Therefore, the second spring portion can have a relatively simple structure.

In a connector according to an aspect 1-8, in any one of the aspects 1-5 to 1-7, the first direction is a terminal front-rear direction, and the second spring portion extends from the fixing-side held portion in the terminal upward direction.

In this aspect, the first direction is a terminal front-rear direction. The second spring portion extends from the fixing-side held portion in the terminal upward direction.

Therefore, the second spring portion can be disposed using a space above the terminal of the fixing-side held portion.

In a connector according to an aspect 1-9, in the aspect 1-8, the fixing-side held portion is press-fitted into the fixed housing with the terminal upward direction as a press-fitting direction, and the second spring portion includes a weak-curved portion slightly bent in the plate thickness direction.

In this aspect, the fixing-side held portion is press-fitted into the fixed housing with the terminal upward direction as a press-fitting direction.

Therefore, the second spring portion extending from the fixing-side held portion in the terminal upward direction tends to interfere with a press-fitting process.

The second spring portion includes a weak-curved portion slightly bent in the plate thickness direction.

Therefore, the second spring portion can be slightly inclined in a direction not interfering with the press-fitting process.

In a connector according to an aspect 1-10, in any one of the aspects 1-1 to 1-10, the first direction is a terminal front-rear direction, and the first spring portion is located between the fixing-side held portion and the movable-side held portion in the terminal front-rear direction.

In this aspect, the first direction is a terminal front-rear direction. The first spring portion is located between the fixing-side held portion and the movable-side held portion in the terminal front-rear direction.

Therefore, it is possible to avoid an increase in size of the terminal in the terminal up-down direction.

In a connector according to an aspect 1-11, in any one of the aspects 1-1 to 1-10, the intermediate portion is branched.

In this aspect, the intermediate portion is branched.

Therefore, the surface area of the intermediate portion is enlarged. As a result, an increase in temperature of the terminal can be suppressed.

In the embodiment described later, the entire intermediate portion is branched into two branch portions. However, the intermediate portion of this aspect is not limited thereto.

In a connector according to an aspect 1-12, in the aspect 1-11, the intermediate portion has a symmetrical shape in the terminal width direction.

In this aspect, the intermediate portion has a symmetrical shape in the terminal width direction.

Therefore, it is possible to impart symmetry to the movable force.

In a connector according to an aspect 1-13, in any one of the aspects 1-1 to 1-12, the intermediate portion does not include a portion whose plate thickness direction faces a direction intersecting a plane perpendicular to the terminal width direction.

In this aspect, the intermediate portion does not include a portion whose plate thickness direction faces a direction intersecting a plane perpendicular to the terminal width direction.

Therefore, the movable force in the direction parallel to the plane perpendicular to the terminal width direction is easily reduced.

### (Second Aspect)

A connector according to an aspect 2-1 includes: a terminal; and a housing, wherein the terminal includes a held portion held by the housing and two branch portions extending from the held portion, the two branch portions extend from positions different from each other in a terminal width direction, the held portion is press-fitted into the housing with a direction perpendicular to the terminal width direction as a press-fitting direction, the held portion is held by the housing at a position between the two branch portions in the terminal width direction, and end surfaces on both sides in the width direction of the held portion are not in contact with the housing.

In this aspect, the connector includes a terminal and a housing.

The terminal includes a held portion and two branch portions. The held portion is held by the housing. The two branch portions extend from the held portion. The two branch portions extend from positions different from each other in a terminal width direction. The held portion is press-fitted into the housing with a direction perpendicular to the terminal width direction as a press-fitting direction.

In the connector disclosed in Patent Literature 1, the held portion is held by the housing in a state where the end surfaces on both sides in the width direction of the held portion are in contact with the housing. Therefore, it is necessary to provide a structure corresponding to this in the housing.

On the other hand, in this aspect, the held portion is held by the housing at a position between the two branch portions in the terminal width direction. End surfaces on both sides in the width direction of the held portion are not in contact with the housing.

Therefore, it is not necessary to provide, in the housing, a structure for holding the held portion in contact with the end surfaces on both sides in the width direction of the held portion.

In the embodiment described later, the two branch portions extend from the held portion in the press-fitting direction. However, the two branch portions of this aspect are not limited thereto. The two branch portions of this aspect may extend outward from the held portion in the terminal width direction.

In the embodiment described later, the connector includes a fixed housing and a movable housing, and the fixed housing corresponds to the “housing” of this aspect. However, this aspect is not limited thereto. The connector of this aspect need not include a movable housing.

In the embodiment described later, the two branch portions are intermediate portions. However, the two branch portions of this aspect are not limited thereto. The two branch portions of this aspect may be two connection pieces to be connected to an attachment object. The two branch portions of this aspect may be two contact pieces that come into contact with a connection object.

In the embodiment described later, the housing is a fixed housing. However, the housing of this aspect is not limited thereto, and may be a movable housing.

In the embodiment described later, the connector includes a movable housing. However, the connector of this aspect is not limited thereto, and does not necessarily include a movable housing.

In the embodiment described later, the connector includes a plurality of terminals adjacent to each other in the terminal width direction. In this case, according to the terminal structure of this aspect, a creepage distance between the plurality of terminals adjacent to each other can be increased. However, the connector of this aspect is not limited thereto, and does not necessarily include a plurality of terminals adjacent to each other in the terminal width direction.

In the embodiment described later, the terminal includes an intermediate portion including two branch portions. However, the terminal of this aspect is not limited thereto. The terminal of this aspect may include an intermediate portion including three or more branch portions. In other words, the terminal may include a branch portion other than the “two branch portions” of this aspect.

In the embodiment described later, the press-fitting direction is a terminal upward direction. However, the press-fitting direction of this aspect is not limited thereto, and may be a terminal downward direction.

In a connector according to an aspect 2-2, in the 2-1, the held portion includes: a base portion from which the two branch portions extend; and a press-fit protrusion protruding in the press-fitting direction from a portion between portions of the base portion from which the two branch portions extend.

In this aspect, the held portion includes a base portion and a press-fit protrusion. The two branch portions extend from the base portion. The press-fit protrusion protrudes in the press-fitting direction from a portion between portions of the base portion from which the two branch portions extend.

Therefore, the held portion can be held by the housing with the press-fit protrusion.

The press-fit protrusion is held by the housing in a state where end surfaces on both sides in the width direction of the press-fit protrusion are in contact with the housing.

In a connector according to an aspect 2-3, in the aspect 2-1, the held portion includes a base portion from which the two branch portions extend, and the base portion is held by the housing in a state where both surfaces of the base portion are in contact with the housing.

In this aspect, the base portion is held by the housing in a state where both surfaces of the base portion are in contact with the housing.

Therefore, the base portion can be appropriately held by the housing.

In a connector according to an aspect 2-4, in the aspect 2-2, the base portion is held by the housing in a state where both surfaces of the base portion are in contact with the housing.

In this aspect, the base portion is held by the housing in a state where both surfaces of the base portion are in contact with the housing.

Therefore, the held portion can be appropriately held by the housing not only at the press-fit protrusion but also at the base portion.

In a connector according to an aspect 2-5, in any one of the aspects 2-1 to 2-4, at least one of the two branch portions includes a press-fitting direction portion extending in the press-fitting direction from the held portion, and the press-fitting direction portion includes a width-direction elongated portion elongated outward in the width direction.

In this aspect, at least one of the two branch portions includes a press-fitting direction portion extending in the press-fitting direction from the held portion.

Therefore, as compared with an aspect in which none of the two branch portions has the press-fitting direction portion, a space can be effectively used to secure the length of the branch portion.

In this aspect, the press-fitting direction portion includes a width-direction elongated portion elongated outward in the width direction.

Therefore, as compared with an aspect in which the press-fitting direction portion does not include the width-direction elongated portion, the length of the branch portion can be secured in the press-fitting direction portion.

Unlike this aspect, in an aspect in which the base portion is held by the housing in a state where the end surface on the outer side in the width direction of the base portion is in contact with the housing, the press-fitting direction portion including the width-direction elongated portion interferes with the housing, so that it is difficult to press-fit the base portion so as to be held by the housing. However, since this aspect is not an aspect in which the base portion is held by the housing in a state where the end surface on the outer side in the width direction of the base portion is in contact with the housing, such a problem does not occur.

In the embodiment described later, the press-fitting direction portion extends from the held portion in the press-fitting direction and extends in the press-fitting direction. However, the press-fitting direction portion of this aspect is not limited thereto. The press-fitting direction portion of this aspect may extend outward from the held portion in the terminal width direction and then extend in the press-fitting direction.

In a connector according to an aspect 2-6, in the aspect 2-4, at least one of the two branch portions includes a press-fitting direction portion extending in the press-fitting direction from the base portion, and the press-fitting direction portion includes a width-direction elongated portion elongated outward in the width direction.

In this aspect, in the aspect 2-4, the length of the branch portion can be further secured.

In a connector according to an aspect 2-7, in any one of the aspects 2-1 to 2-6, the housing includes a width-direction extending portion extending in the width direction, and the width-direction extending portion includes: a contact surface coming into contact with one surface of the held portion; and a recess located on an outer side in the width direction with respect to the contact surface.

In this aspect, the housing includes a width-direction extending portion extending in the width direction. The width-direction extending portion includes a contact surface coming into contact with one surface of the held portion, and a recess located on an outer side in the width direction with respect to the contact surface.

Therefore, it is possible to avoid contact between the width-direction extending portion and the held portion of the terminal at the position where the recess is formed.

In the embodiment described later, a pair of recesses is formed on both sides in the width direction with respect to the contact surface. However, this aspect is not limited thereto. The recess may be formed only on one side in the width direction with respect to the contact surface.

### BRIEF DESCRIPTION OF DRAWINGS

FIG. 1 is a perspective view of a connector.

FIG. 2 is an exploded perspective view of the connector.

FIG. 3A is a perspective view of a terminal.

FIG. 3B is a cross-sectional perspective view of the terminal.

FIG. 4 is a cross-sectional view of the connector.

FIG. 5 is a perspective view of a fixed housing.

FIG. 6 is a cross-sectional view illustrating a structure of a holding wall of the fixed housing.

FIG. 7 is a cross-sectional view corresponding to FIG. 6 illustrating a state where the terminal is held.

FIG. 8 is another cross-sectional view illustrating a structure of the holding wall of the fixed housing.

FIG. 9 is a cross-sectional view corresponding to FIG. 8 illustrating a state where the terminal is held.

FIG. 10 is a cross-sectional view illustrating a part of a connector of a modification.

### DESCRIPTION OF EMBODIMENTS

Hereinafter, preferred embodiments of a connector according to the disclosure will be described.

An arrow X direction, an arrow Y direction, and an arrow Z direction illustrated in each drawing are defined as one side in a connector width direction, a connector forward direction, and a connector upward direction, respectively. However, these terms do not limit the posture of the connector in the use state.

The connector width direction may be referred to as a pitch direction, the connector forward direction may be referred to as one side in an inter-row direction, and a connector rear direction may be referred to as the other side in the inter-row direction.

### Connector 10

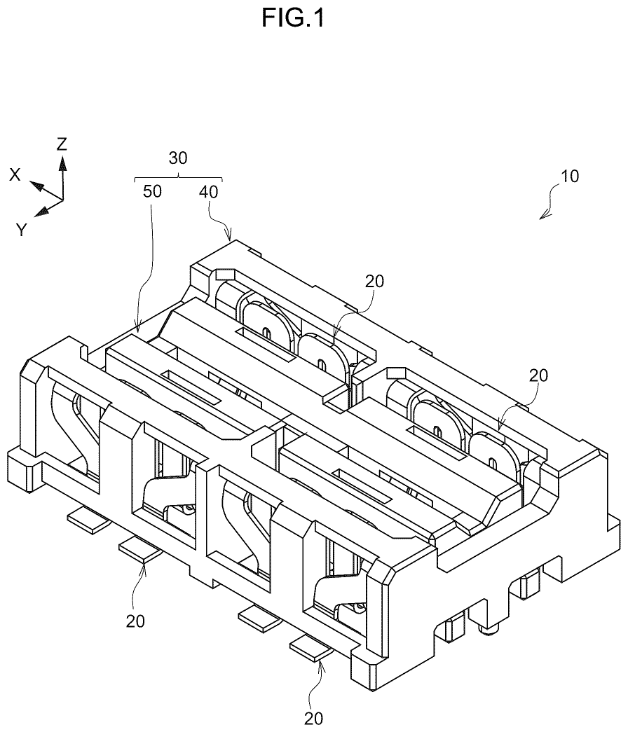

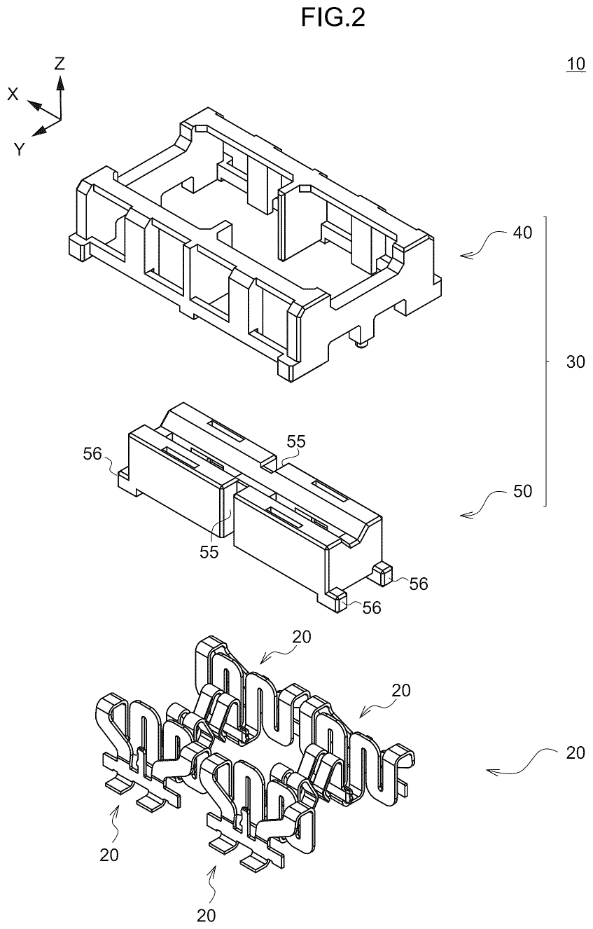

FIGS. 1 and 2 illustrate a connector 10 of this embodiment.

The connector 10 includes a terminal portion 20 and a housing portion 30.

As illustrated in FIG. 2, the terminal portion 20 includes one or more terminals 20. For simplicity, the terminal portion 20 and the terminal 20 are denoted by the same reference numerals.

In this embodiment, the terminal portion 20 includes a plurality of (four) terminals 20. Specifically, the terminal portion 20 includes a plurality of (two) terminals 20 on one side in the inter-row direction and a plurality of (two) terminals 20 on the other side in the inter-row direction.

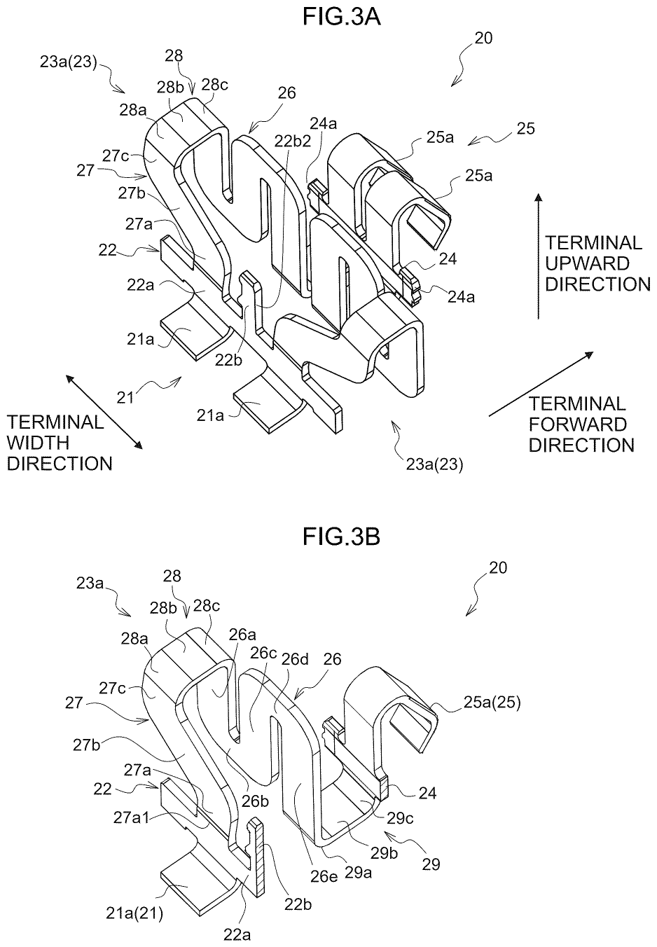

The terminals 20 on one side in the inter-row direction and the terminals 20 on the other side in the inter-row direction are arranged in a posture facing each other in a terminal forward direction (see FIG. 3A). In other words, each of the plurality of terminals 20 is disposed with its terminal forward direction facing the inner side in the inter-row direction.

The plurality of terminals 20 have the same structure

The housing portion 30 includes a fixed housing 40 and a movable housing 50.

The fixed housing 40 is configured to be immovable with respect to an attachment object 90. Specifically, the fixed housing 40 is fixed to the attachment object 90 via the terminal portion 20. Hereinafter, the fixed housing 40 may be simply referred to as the housing 40.

The movable housing 50 is configured to be movable with respect to the attachment object 90. Specifically, the movable housing 50 is movably supported by the terminal portion 20.

### Terminal 20

FIGS. 3A and 3B illustrate the terminal 20.

The terminal 20 is disposed such that the terminal forward direction faces the inner side of the inter-row direction and the terminal upward direction faces the connector upward direction. The terminal width direction is parallel to the connector width direction.

The terminal 20 includes a connection portion 21, a fixing-side held portion 22, an intermediate portion 23, a movable-side held portion 24, and a contact portion 25.

The connection portion 21 is connected to the attachment object 90. The attachment object 90 is, for example, a substrate.

The fixing-side held portion 22 is held by the fixed housing 40.

The intermediate portion 23 is elongated from the fixing-side held portion 22 to the movable-side held portion 24. The intermediate portion 23 is configured to allow relative movement of the movable-side held portion 24 with respect to the fixing-side held portion 22.

The movable-side held portion 24 is held by the movable housing 50.

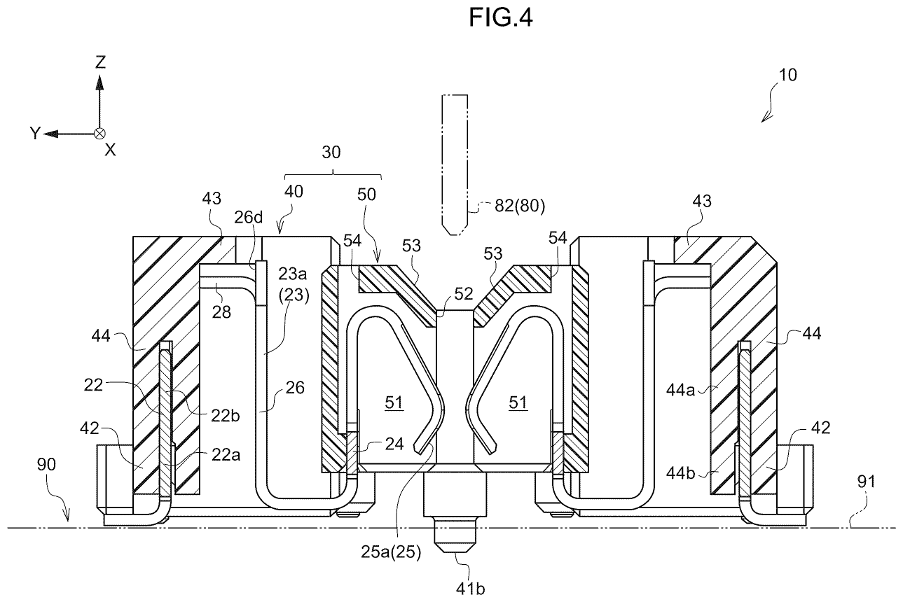

The contact portion 25 comes into contact with a connection object (not illustrated). Specifically, the contact portion 25 comes into contact with a mating contact portion 82 of a mating terminal 80 of a mating connector as a connection object (not illustrated) (see FIG. 4).

The connection portion 21 is branched into two connection pieces 21a.

The connection portion 21 is soldered to an attachment surface 91 of the attachment object 90. Specifically, each of the two connection pieces 21a is soldered to the attachment surface 91 of the attachment object 90.

The fixing-side held portion 22 is held by the fixed housing 40 by being press-fitted into the fixed housing 40. The press-fitting direction of the fixing-side held portion 22 with respect to the fixed housing 40 is the terminal upward direction.

The fixing-side held portion 22 has a flat plate shape, and has a plate thickness direction facing the terminal front-rear direction.

The fixing-side held portion 22 includes a base portion 22a and a press-fit protrusion 22b.

The base portion 22a has a shape extending in the terminal width direction, and specifically, has a substantially rectangular shape with the terminal width direction as a longitudinal direction. The two connection pieces 21a extend from the base portion 22a.

The press-fit protrusion 22b protrudes in the terminal upward direction from the central position in the width direction of the base portion 22a.

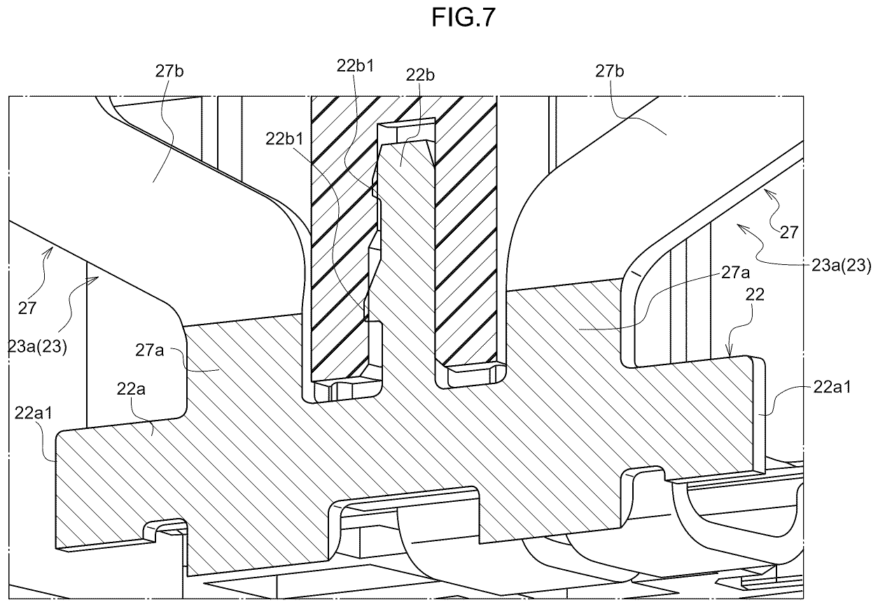

As illustrated in FIG. 7, the press-fit protrusion 22b includes a protrusion 22b1. The protrusion 22b1 is formed only on one end surface of the two end surfaces on the outer side in the terminal width direction of the press-fit protrusion 22b. The other end surface 22b2 (see FIG. 3A) of the two end surfaces on the outer side in the terminal width direction of the press-fit protrusion 22b linearly extends in the terminal up-down direction.

The intermediate portion 23 has a shape that changes its plate thickness direction in a plane perpendicular to the terminal width direction.

The intermediate portion 23 includes two branch portions 23a. The two branch portions 23a extend from the base portion 22a in the terminal upward direction. The two branch portions 23a have a symmetrical structure in the terminal width direction. Therefore, the two branch portions 23a have the same structure as each other.

The branch portion 23a includes a first spring portion 26 and a second spring portion 27. The first spring portion 26 is located on the terminal front side with respect to the second spring portion 27, and is located on the terminal rear side with respect to the movable-side held portion 24.

The branch portion 23a includes a first coupling portion 28 that couples the second spring portion 27 and the first spring portion 26 to each other, and a second coupling portion 29 that couples the first spring portion 26 and the movable-side held portion 24 to each other.

A terminal end of the second spring portion 27 is located above the terminal with respect to a starting end of the second spring portion 27. In this embodiment, the starting end of the second spring portion 27 is a boundary portion between the base portion 22a and the second spring portion 27, and the terminal end of the second spring portion 27 is a boundary portion between the second spring portion 27 and the first coupling portion 28.

A terminal end of the first spring portion 26 is located below the terminal with respect to a starting end of the first spring portion 26. In this embodiment, the starting end of the first spring portion 26 is a boundary portion between the first coupling portion 28 and the first spring portion 26, and the terminal end of the first spring portion 26 is a boundary portion between the first spring portion 26 and the second coupling portion 29.

The first coupling portion 28 has a shape that changes its plate thickness direction in a plane perpendicular to the terminal width direction. In the first coupling portion 28, the elongation direction of the intermediate portion 23 is reversed from the upward direction to the downward direction.

The second coupling portion 29 has a shape that changes its plate thickness direction in a plane perpendicular to the terminal width direction. In the second coupling portion 29, the elongation direction of the intermediate portion 23 is reversed from the downward direction to the upward direction.

As illustrated in FIG. 3B, the first spring portion 26 includes a first downward-direction elongated portion 26a, an upward-direction elongated portion 26c, and a second downward-direction elongated portion 26e.

The first spring portion 26 includes a first width-direction elongated portion 26b that connects the first downward-direction elongated portion 26a and the upward-direction elongated portion 26c, and a second width-direction elongated portion 26d that connects the upward-direction elongated portion 26c and the second downward-direction elongated portion 26e.

The elongation direction of the first downward-direction elongated portion 26a is the terminal downward direction.

The elongation direction of the upward-direction elongated portion 26c is the terminal upward direction.

The elongation direction of the second downward-direction elongated portion 26e is the terminal downward direction.

Thus, the first spring portion 26 has an S-shape. The first spring portion 26 has a flat plate shape as a whole. In other words, the first spring portion 26 does not have a curved portion bent in the plate thickness direction. The plate thickness direction of the first spring portion 26 is parallel to the terminal front-rear direction (first direction).

The second spring portion 27 includes a first upper elongated portion 27a, a width-direction elongated portion 27b, and a second upper elongated portion 27c.

The elongation direction of the first upper elongated portion 27a is generally the terminal upward direction.

The elongation direction of the width-direction elongated portion 27b is generally a direction outward in the terminal width direction and oblique in the terminal upward direction.

The elongation direction of the second upper elongated portion 27c is generally the terminal upward direction.

The first upper elongated portion 27a includes a weak-curved portion 27a1 slightly bent in the terminal front side. As a result, the plate thickness direction of a portion of the second spring portion 27 on the other end side with respect to the weak-curved portion 27a1 (a portion on the movable-side held portion 24 side) is slightly inclined with respect to the terminal front-rear direction. The width-direction elongated portion 27b and the second upper elongated portion 27c belong to the inclined portion. An inclination angle of the inclined portion in the plate thickness direction with respect to the terminal front-rear direction is, for example, 5 to 30 degrees.

Therefore, the plate thickness direction of most of the second spring portion 27 faces a direction slightly inclined with respect to the terminal front-rear direction.

It can be said that the second spring portion 27 extends in the press-fitting direction (terminal upward direction) from the base portion 22a of the fixing-side held portion 22. Here, the press-fitting direction is the press-fitting direction of the fixing-side held portion 22. Hereinafter, the second spring portion 27 may be referred to as a press-fitting direction portion 27.

The first coupling portion 28 includes a pair of curved portions 28a and 28c and a straight portion 28b.

The second coupling portion 29 includes a pair of curved portions 29a and 29c and a straight portion 29b.

An upper end of the second width-direction elongated portion 26d is located above an upper end of the first coupling portion 28 (see FIG. 4). As described above, by setting the upper end position of the first spring portion 26 to a high position, the spring length of the first spring portion 26 can be increased. More specifically, the upper end of the first spring portion 26 (the upper end of the second width-direction elongated portion 26d) is located above a lower surface of a second width-direction extending portion 43 of the fixed housing 40 described later (see FIG. 4).

The movable-side held portion 24 is held by the movable housing 50 by being press-fitted into the movable housing 50. The press-fitting direction of the movable-side held portion 24 with respect to the movable housing 50 is the upward direction.

The movable-side held portion 24 has a flat plate shape, and has a plate thickness direction facing the terminal front-rear direction. The movable-side held portion 24 has a substantially rectangular shape whose longitudinal direction is the terminal width direction. The movable-side held portion 24 is held by the fixed housing 40 in a state where the end surface on the outer side in the width direction of the movable-side held portion 24 is in contact with the fixed housing 40. A projection 24a is formed on the end surface on the outer side in the width direction of the movable-side held portion 24.

The contact portion 25 includes two contact pieces 25a. The two contact pieces 25a extend from the movable-side held portion 24 in the terminal upward direction. The two contact pieces 25a have the same shape.

The contact portion 25 extends from the movable-side held portion 24 in the terminal upward direction and then is bent so as to be folded back to the terminal front side. In the bent portion, the elongation direction of the contact portion 25 is reversed in the terminal up-down direction. The contact portion 25 comes into contact with the mating contact portion 82 on the tip side of the bent portion.

### Fixed Housing 40

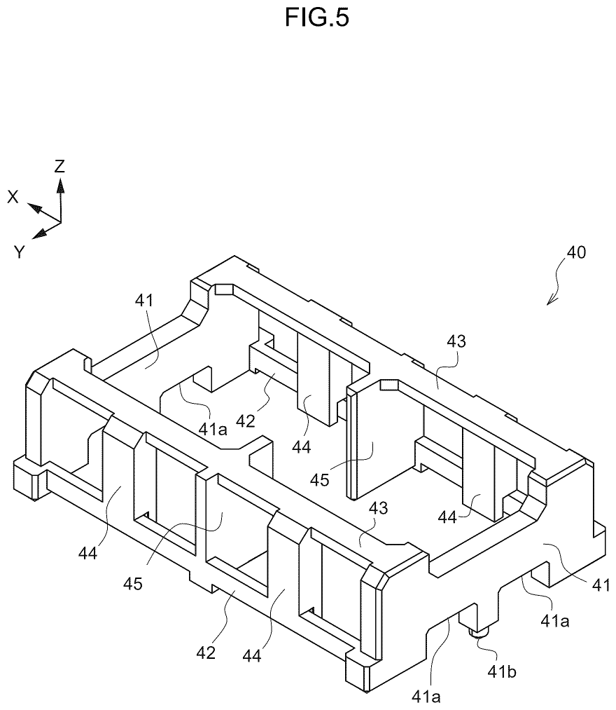

FIG. 5 illustrates the fixed housing 40.

The fixed housing 40 includes a pair of width-direction outer walls 41, a pair of first width-direction extending portions 42, a pair of second width-direction extending portions 43, a plurality of (four) holding walls 44, and a plurality of (two) partition walls 45.

The pair of width-direction outer walls 41 is located at ends on the outer side in the width direction of the fixed housing 40.

The first width-direction extending portion 42 extends in the connector width direction. The first width-direction extending portion 42 couples the pair of width-direction outer walls 41 to each other in the connector width direction. The first width-direction extending portion 42 is located at an end on the outer side in the inter-row direction of the fixed housing 40.

The second width-direction extending portion 43 extends in the connector width direction. The second width-direction extending portion 43 couples the pair of width-direction outer walls 41 to each other in the connector width direction. The second width-direction extending portion 43 is located at an end on the upper side of the fixed housing 40. The second width-direction extending portion 43 covers a part of the terminal 20 from above (see FIG. 4).

The holding wall 44 holds the fixing-side held portion 22 of the terminal 20. The holding wall 44 couples the first width-direction extending portion 42 and the second width-direction extending portion 43 to each other in the connector up-down direction. Front-rear-direction open windows are formed on both sides in the width direction of the holding wall 44. Since the front-rear-direction open windows are formed, a part of the terminal 20 is not covered with the fixed housing 40 in a case in which the connector 10 is viewed from the connector front-rear direction. This facilitates heat dissipation.

The partition wall 45 is located between the two terminals 20 adjacent to each other in the pitch direction. Thus, the partition wall 45 prevents a short circuit between the two terminals 20 adjacent to each other in the pitch direction.

The width-direction outer wall 41 includes a plurality of restraining recesses 41a. Two restraining recesses 41a are formed for each of the pair of width-direction outer walls 41.

The fixed housing 40 includes two bosses 41b. Positioning of the fixed housing 40 with respect to the attachment object 90 is ensured by the two bosses 41b. The boss 41b protrudes downward from a portion between the two restraining recesses 41a in the pair of width-direction outer walls 41.

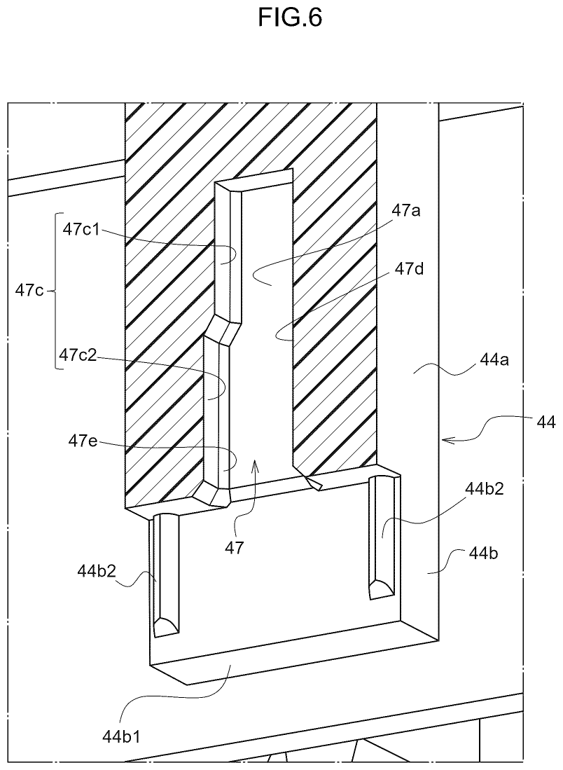

As illustrated in FIGS. 6 to 9, the holding wall 44 includes a press-fitting hole 47. The press-fit protrusion 22b of the terminal 20 is press-fitted into the press-fitting hole 47. The press-fitting hole 47 is formed in a general portion 44a of the holding wall 44.

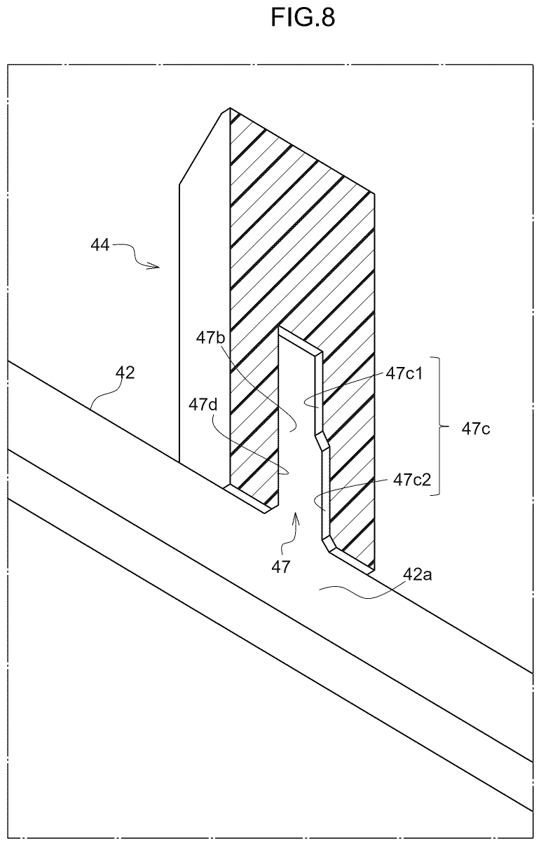

The press-fitting hole 47 includes an inter-row direction inner lateral surface 47a (see FIG. 6) and an inter-row direction outer lateral surface 47b (see FIG. 8).

The inter-row direction inner lateral surface 47a is a plane facing the outer side in the inter-row direction.

The inter-row direction outer lateral surface 47b is a plane facing the inner side in the inter-row direction.

As illustrated in FIGS. 6 and 8, the press-fitting hole 47 includes one lateral surface 47c in the width direction and the other lateral surface 47d in the width direction.

The one lateral surface 47c in the width direction is a plane facing the other side in the width direction.

The other lateral surface 47d in the width direction is a plane facing one side in the width direction.

The one lateral surface 47c in the width direction includes a back lateral surface 47c1 and a front lateral surface 47c2.

The back lateral surface 47c1 is located on the other side in the width direction with respect to the front lateral surface 47c2.

The protrusion 22b1 on the back side in the press-fitting direction of the press-fit protrusion 22b bites into the back lateral surface 47c1.

The protrusion 22b1 on the front side in the press-fitting direction of the press-fit protrusion 22b bites into the front lateral surface 47c2.

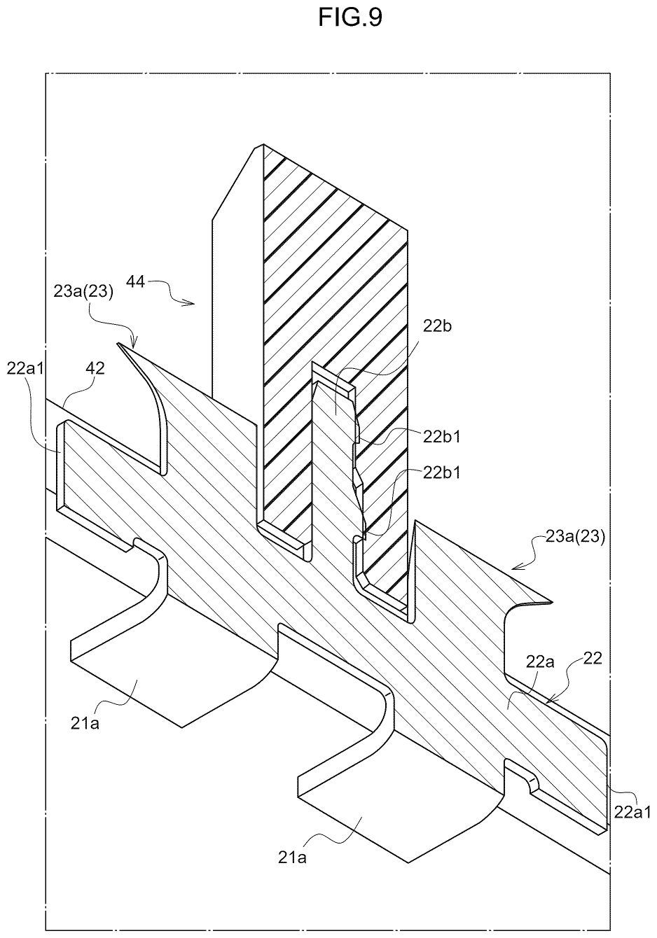

The end surface 22b2 (see FIG. 3A) on the other side in the width direction of the press-fit protrusion 22b of the terminal 20 is in contact with the other lateral surface 47d in the width direction over the up-down direction (see FIGS. 7 and 9). As a result, the terminal 20 is prevented from being inclined with respect to the fixed housing 40 in a state where the terminal 20 is held by the fixed housing 40. In other words, the terminal upward direction is prevented from being inclined with respect to the connector upward direction.

As illustrated in FIG. 6, the press-fitting hole 47 includes a pair of coupling surfaces 47e. However, in FIG. 6, the other coupling surface 47e of the one coupling surface 47e is hidden.

One coupling surface 47e diagonally couples the inter-row direction inner lateral surface 47a and the one lateral surface 47c in the width direction to each other.

The other coupling surface 47e diagonally couples the inter-row direction inner lateral surface 47a and the other lateral surface 47d in the width direction to each other.

With the pair of coupling surfaces 47e, it is easy to realize a state where the press-fit protrusion 22b of the terminal 20 is in contact with the inter-row direction outer lateral surface 47b among the inter-row direction inner lateral surface 47a and the inter-row direction outer lateral surface 47b. It is easy to realize a state where the base portion 22a of the terminal 20 is in contact with a contact surface 42a of the first width-direction extending portion 42 (see FIG. 8).

As illustrated in FIG. 6, the holding wall 44 includes a clamping portion 44b in addition to the general portion 44a.

As illustrated in FIG. 4, the clamping portion 44b clamps a part of the base portion 22a of the terminal 20 with the first width-direction extending portion 42. The clamping portion 44b protrudes from the general portion 44a of the holding wall 44 in the connector downward direction. The clamping portion 44b is located on the inner side in the inter-row direction with respect to the first width-direction extending portion 42.

As illustrated in FIG. 6, the clamping portion 44b includes a main body portion 44b1 and two protrusions 44b2.

The shape of the main body portion 44b1 is a rectangular parallelepiped.

The protrusion 44b2 protrudes outward in the inter-row direction (terminal rear side) from the main body portion 44b1 of the clamping portion 44b. Therefore, the surface on the terminal front side of the base portion 22a of the terminal 20 comes into contact with the two protrusions 44b2. A surface of the base portion 22a of the terminal 20 on the terminal rear side comes into contact with the contact surface 42a of the first width-direction extending portion 42 (see FIG. 8). The contact surface 42a of the first width-direction extending portion 42 is a plane, and is flush with the inter-row direction outer lateral surface 47b of the press-fitting hole 47.

The protrusion 44b2 extends in the up-down direction. An upper end of the protrusion 44b2 is connected to the general portion 44a of the holding wall 44. A lower end of the protrusion 44b2 is located above a lower end of the clamping portion 44b.

### Movable Housing 50

As illustrated in FIG. 4, the movable housing 50 includes a housing space 51 that houses the contact portion 25 of the terminal 20.

The movable housing 50 includes an insertion port 52 into which the mating contact portion 82 of the mating terminal 80 is inserted. The shape of the mating contact portion 82 is a plate shape with the inter-row direction as a plate thickness direction, and the insertion port 52 is a rectangular shape elongated in the connector width direction as viewed from the connector upward direction. The longitudinal length of the insertion port 52 is a length with a margin with respect to the longitudinal length of the mating contact portion 82. As a result, a slight positional shift of the mating contact portion 82 in the connector width direction is allowed.

The number of insertion ports 52 provided is two. That is, one insertion port 52 is provided for the pair of terminals 20 adjacent to each other in the inter-row direction. Correspondingly, a pair of housing spaces 51 adjacent to each other in the inter-row direction is coupled to each other in the inter-row direction. The contact portion 25 of the terminal 20 on one side in the inter-row direction comes into contact with the mating contact portion 82 from one side in the inter-row direction, and the contact portion 25 of the terminal 20 on the other side in the inter-row direction comes into contact with the same mating contact portion 82 from the other side in the inter-row direction.

The movable housing 50 includes a pair of guide surfaces 53. The pair of guide surfaces 53 is inclined in a direction in which the mating contact portion 82 is guided to the insertion port 52 in the connector front-rear direction.

The movable housing 50 does not include a guide surface inclined in a direction in which the mating contact portion 82 is guided to the insertion port 52 in the connector width direction.

The movable housing 50 includes an upper open window 54. The housing space 51 is opened upward through the upper open window 54. The upper open window 54 contributes to exhausting of heat. A plurality of (four) upper open windows 54 are formed corresponding to the housing space 51.

As illustrated in FIG. 2, the movable housing 50 includes recesses 55.

The recesses 55 are configured such that a part of the partition wall 45 of the fixed housing 40 can enter. The movable range of the movable housing 50 in the connector front-rear direction is ensured by the recesses 55. The partition wall 45 can be formed large on the inner side in the inter-row direction.

As illustrated in FIGS. 1 and 4, in a normal state, a part of the partition wall 45 enters the recesses 55 of the movable housing 50. The normal state described here refers to a state where no external force is applied to the terminal 20 and the movable housing 50 (for example, a state where a connection object is not connected to the connector 10).

The movable housing 50 includes a plurality of restrained portions 56. Each restrained portion 56 protrudes outward in the connector width direction from the movable housing 50. A total of four restrained portions 56 are formed.

### <Operational Effects>

Next, operational effects of this embodiment will be described.

In this embodiment, as illustrated in FIG. 4, the connector 10 is a connector to be used by being attached to the attachment surface 91 of the attachment object 90.

The connector 10 includes the terminal 20, the fixed housing 40, and the movable housing 50. The fixed housing 40 is fixed to the attachment object 90. The movable housing 50 is movable with respect to the fixed housing 40.

The terminal 20 includes the fixing-side held portion 22, the movable-side held portion 24, and the intermediate portion 23. The fixing-side held portion 22 is held by the fixed housing 40. The movable-side held portion 24 is held by the movable housing 50. The intermediate portion 23 is elongated from the fixing-side held portion 22 to the movable-side held portion 24.

Here, as illustrated in FIG. 3A, the intermediate portion 23 includes the first spring portion 26. The first spring portion 26 enables movement of the movable-side held portion 24 with respect to the fixing-side held portion 22. A plate thickness direction of the first spring portion 26 is substantially parallel to a first direction (a terminal front-rear direction in this embodiment).

Therefore, the movable force in the first direction can be reduced by the first spring portion 26.

The movable force in the first direction means a force required to move the movable housing 50 in the first direction. The term “substantially parallel” as used herein includes not only a parallel relationship but also a slightly inclined relationship.

In this embodiment, as illustrated in FIG. 3B, the first spring portion 26 includes the width-direction elongated portion 26b. The width-direction elongated portion 26b is a portion having a component whose elongation direction is a terminal width direction.

Therefore, as compared with an aspect in which the first spring portion does not include the width-direction elongated portion (see, for example, the connector disclosed in Patent Literature 1), the length of the first spring portion 26 can be secured without increasing the size of the first spring portion 26 in the terminal front-rear direction and the terminal up-down direction. Therefore, it is possible to realize a connector that has a desired movable force and is small in a direction corresponding to a terminal front-rear direction and a terminal up-down direction.

In this embodiment, the first direction is a terminal front-rear direction.

Therefore, the movable force in the terminal front-rear direction can be reduced by the first spring portion 26.

In this embodiment, as illustrated in FIG. 3B, in the width-direction elongated portion 26b of the first spring portion 26, the elongation direction of the first spring portion 26 is reversed in the second direction. The second direction is a direction perpendicular to both the first direction and the terminal width direction, and is the terminal up-down direction in this embodiment.

Therefore, the spring length of the first spring portion 26 can be secured without increasing the size of the first spring portion 26 in the first direction.

In this embodiment, the first spring portion 26 includes the first width-direction elongated portion 26b that is the above-described width-direction elongated portion 26b, and the second width-direction elongated portion 26d that is a portion having a component whose elongation direction is the terminal width direction.

Here, also in the second width-direction elongated portion 26d, the elongation direction of the first spring portion 26 is reversed in the second direction.

Therefore, the spring length of the first spring portion 26 can be further secured.

In this embodiment, the intermediate portion 23 includes the second spring portion 27. The second spring portion 27 enables movement of the movable-side held portion 24 with respect to the fixing-side held portion 22. The plate thickness direction of the second spring portion 27 is substantially parallel to the first direction.

Therefore, the movable force in the first direction can be reduced by the second spring portion 27.

The second spring portion 27 is located at a position different from the first spring portion 26 in the first direction. The intermediate portion 23 includes a coupling portion 28 that couples the first spring portion 26 and the second spring portion 27 to each other.

Therefore, the spring length of the intermediate portion 23 can be secured using a space in the first direction.

In this embodiment, as illustrated in FIGS. 3A and 3B, the second spring portion 27 includes a width-direction elongated portion 27b that is a portion having a component whose elongation direction is the terminal width direction.

Therefore, the spring length of the second spring portion 27 can be increased as compared with an aspect in which the second spring portion 27 does not include the width-direction elongated portion 27b.

In this embodiment, in the width-direction elongated portion 27b of the second spring portion 27, the elongation direction of the second spring portion 27 is not reversed in the second direction.

Therefore, the second spring portion 27 can have a relatively simple structure.

In this embodiment, the first direction is a terminal front-rear direction. The second spring portion 27 extends from the fixing-side held portion 22 in the terminal upward direction. Therefore, the second spring portion 27 can be disposed using a space on the terminal upward direction of the fixing-side held portion 22.

In this embodiment, the fixing-side held portion 22 is press-fitted into the fixed housing 40 with the terminal upward direction as a press-fitting direction.

Therefore, the second spring portion 27 extending from the fixing-side held portion 22 in the terminal upward direction tends to interfere with a press-fitting process.

The second spring portion 27 includes a weak-curved portion 27a1 slightly bent in the plate thickness direction.

Therefore, the second spring portion 27 can be slightly inclined in a direction not interfering with the press-fitting process.

In this embodiment, the first direction is a terminal front-rear direction. The first spring portion 26 is located between the fixing-side held portion 22 and the movable-side held portion 24 in the terminal front-rear direction.

Therefore, it is possible to avoid an increase in size of the terminal 20 in the terminal up-down direction.

In this embodiment, the intermediate portion 23 is branched.

Therefore, the surface area of the intermediate portion 23 is enlarged. As a result, an increase in temperature of the terminal 20 can be suppressed.

In particular, in this embodiment, the intermediate portion 23 is branched into two branch portions 23a. With respect to a spacing in the terminal width direction between the two branch portions 23a, each branch portion 23a is elongated so as to expand outward in the width direction in the second spring portion 27, and is elongated so as to narrow inward in the width direction in the first spring portion 26.

Therefore, the length of the branch portion 23a can be increased by effectively using the space.

In this embodiment, a spacing in the terminal width direction between terminal ends of the two branch portions 23a is smaller than a spacing in the width direction between starting ends of the two branch portions 23a. The terminal end is a boundary portion between the two branch portions 23a and the movable-side held portion 24, and the starting end is a boundary portion between the two branch portions 23a and the fixing-side held portion 22.

Therefore, the length of the branch portion 23a can be further increased.

In this embodiment, the intermediate portion 23 has a symmetrical shape in the terminal width direction.

Therefore, it is possible to impart symmetry to the movable force.

In this embodiment, the intermediate portion 23 does not include a portion whose plate thickness direction faces a direction intersecting a plane perpendicular to the terminal width direction.

Therefore, the movable force in the direction parallel to the plane perpendicular to the terminal width direction is easily reduced.

### Second Viewpoint

Next, operational effects of this embodiment will be described from a second viewpoint.

In this embodiment, as illustrated in FIGS. 1 and 2, the connector 10 includes the terminal 20 and the housing 40.

As illustrated in FIG. 3A, the terminal 20 includes the held portion 22 and two branch portions 23a. The held portion 22 is held by the housing 40. The two branch portions 23a extend from the held portion 22. The two branch portions 23a extend from positions different from each other in a terminal width direction. The held portion 22 is press-fitted into the housing 40 with a direction perpendicular to the terminal width direction (the terminal upward direction in this embodiment) as a press-fitting direction.

In the connector disclosed in Patent Literature 1, the held portion is held by the housing in a state where the end surfaces on both sides in the width direction of the held portion are in contact with the housing. Therefore, it is necessary to provide a structure corresponding to this in the housing.

On the other hand, in this embodiment, the held portion 22 is held by the housing 40 at a position between the two branch portions 23a in a terminal width direction. End surfaces 22a1 (see FIG. 7) on both sides in the width direction of the held portion 22 are not in contact with the housing 40.

Therefore, it is not necessary to provide, in the housing 40, a structure for holding the held portion 22 in contact with the end surfaces 22a1 on both sides in the width direction of the held portion 22.

In a case in which it is not necessary to provide such a structure in the housing 40, for example, the wall thickness of the partition wall 45 in this embodiment can be reduced. As a result, the connector 10 can be downsized.

In the case of an aspect in which the held portion is held by the housing in a state where end surfaces on both sides in the width direction of the held portion are in contact with the housing, it is necessary to enlarge the base portion 22a of the held portion 22 in the width direction and extend the base portion to the wall of the housing 40.

In this case, in a case in which the connector 10 includes the two terminals 20 adjacent to each other in the pitch direction as in this embodiment, a creepage distance between the two terminals 20 is shortened.

That is, the configuration of this embodiment has an effect of increasing the creepage distance.

In this embodiment, the held portion 22 includes the base portion 22a and the press-fit protrusion 22b. The two branch portions 23a extend from the base portion 22a. The press-fit protrusion 22b protrudes in the press-fitting direction from a portion between portions of the base portion 22a from which the two branch portions 23a extend (the terminal upward direction in this embodiment).

Therefore, the held portion 22 can be held by the housing 40 with the press-fit protrusion 22b.

In this embodiment, as illustrated in FIG. 4, the base portion 22a is held by the housing 40 in a state where both surfaces (surfaces on both sides in the plate thickness direction) of the base portion 22a are in contact with the housing 40.

Therefore, the held portion 22 can be appropriately held by the housing 40 not only at the press-fit protrusion 22b but also at the base portion 22a.

In this embodiment, at least one of the two branch portions 23a includes the press-fitting direction portion 27 extending in the press-fitting direction from the base portion 22a. Here, the press-fitting direction is the press-fitting direction of the held portion 22.

Therefore, as compared with an aspect in which none of the two branch portions 23a has the press-fitting direction portion 27, a space can be effectively used to secure the length of the branch portion 23a.

In this embodiment, the press-fitting direction portion 27 includes the width-direction elongated portion 27b elongated outward in the terminal width direction.

Therefore, as compared with an aspect in which the press-fitting direction portion 27 does not include the width-direction elongated portion 27b, the length of the branch portion 23a can be secured in the press-fitting direction portion 27.

Unlike this embodiment, in an aspect in which the base portion 22a is held by the housing 40 in a state where the end surface on the outer side in the width direction of the base portion 22a is in contact with the housing 40, the press-fitting direction portion 27 including the width-direction elongated portion 27b interferes with the housing 40, so that it is difficult to press-fit the base portion 22a so as to be held by the housing 40. However, since this embodiment is not an aspect in which the base portion 22a is held by the housing in a state where the end surface 22a1 on the outer side in the width direction of the base portion 22a is in contact with the housing 40, such a problem does not occur.

### Modification

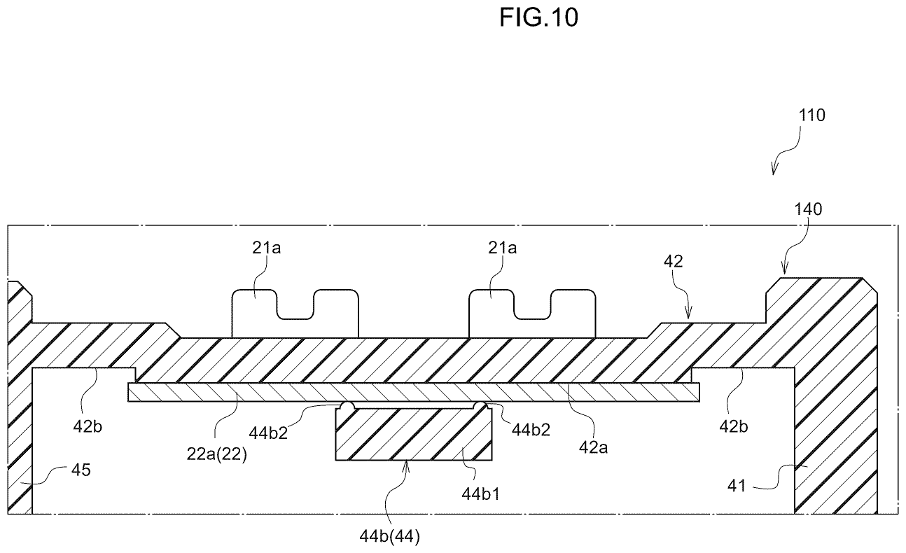

FIG. 10 illustrates a connector 110 according to a modification.

In this modification, the first width-direction extending portion 42 of a fixed housing 140 includes a contact surface 42a coming into contact with one surface of the base portion 22a, and a recess 42b located on an outer side in the width direction with respect to the contact surface 42a.

Therefore, it is possible to avoid contact between the first width-direction extending portion 42 and the base portion 22a of the terminal 20 at the position where the recess 42b is formed. As a result, a creepage distance between the terminals 20 adjacent to each other can be increased.

### [Supplementary Description of Above Embodiment]

Although the preferred embodiment of the connector of the disclosure has been described above, the disclosure is not limited thereto. The following description is a supplement just in case.

In the above embodiment, the fixed housing 40 and the movable housing 50 are synthetic resin molded products. However, the housing of the disclosure is not limited thereto.

In the above embodiment, the intermediate portion 23 does not include a width-direction elongated portion whose plate thickness direction is substantially parallel to the terminal up-down direction (a portion having a component whose elongation direction is the terminal width direction). However, the intermediate portion of the disclosure is not limited thereto.

### DESCRIPTION OF REFERENCE NUMERALS

10 Connector
20 Terminal
21 Connection portion
21a Connection piece (branch portion)
22 Fixing-side held portion (held portion)
22a1 End surface of held portion on outer side of terminal width direction
22a Base portion
22b Press-fit protrusion
23 Intermediate portion
23a Branch portion
24 Movable-side held portion
26 First spring portion
26b First width-direction elongated portion (width-direction elongated portion)
26d Second width-direction elongated portion
27 Second spring portion (press-fitting direction portion)
27b Width-direction elongated portion
28 First coupling portion (coupling portion)
29 Second coupling portion
40 Fixed housing (housing)
42 First width-direction extending portion (width-direction extending portion)
42a Contact surface
43 Second width-direction extending portion
44 Holding wall
45 Partition wall
47 Press-fitting hole
50 Movable housing
91 Attachment surface

1. A connector comprising:
a terminal; and
a housing, wherein
the terminal includes:
a held portion held by the housing; and
two branch portions extending from the held portion,
the two branch portions extend from positions different from each other in a width direction in the held portion,
the held portion is press-fitted into the housing with a direction perpendicular to the width direction as a press-fitting direction, and
the held portion is held by the housing at a position between the two branch portions in the width direction.

2. The connector according to claim 1, wherein
the held portion includes:
a base portion from which the two branch portions extend; and
a press-fit protrusion protruding in the press-fitting direction from a portion between portions of the base portion from which the two branch portions extend.

3. The connector according to claim 1, wherein
the held portion includes a base portion from which the two branch portions extend, and
the base portion is held by the housing in a state where both surfaces of the base portion are in contact with the housing.

4. The connector according to claim 2, wherein
the base portion is held by the housing in a state where both surfaces of the base portion are in contact with the housing.

5. The connector according to claim 1, wherein
at least one of the two branch portions includes a press-fitting direction portion extending in the press-fitting direction from the held portion, and
the press-fitting direction portion includes a width-direction elongated portion elongated outward in the width direction.

6. The connector according to claim 4, wherein
at least one of the two branch portions includes a press-fitting direction portion extending in the press-fitting direction from the base portion, and
the press-fitting direction portion includes a width-direction elongated portion elongated outward in the width direction.

7. The connector according to claim 1, wherein
the housing includes a width-direction extending portion extending in the width direction, and
the width-direction extending portion includes:
a contact surface coming into contact with one surface of the held portion; and
a recess located on an outer side in the width direction with respect to the contact surface.
